(19) United States
(12) Patent Application Publication
(10) Pub. No.: US 2013/0197958 A1
(43) Pub. Date: Aug. 1, 2013

(54) CRITICAL DATE MANAGEMENT

(71) Applicants: Michael A. Kawecki, Hillsborough, NJ (US); Tara Cummings, Broomfield, CO (US); Andrew Healey, Hants (GB)

(72) Inventors: Michael A. Kawecki, Hillsborough, NJ (US); Tara Cummings, Broomfield, CO (US); Andrew Healey, Hants (GB)

(73) Assignee: TELCORDIA TECHNOLOGIES, INC., Piscataway, NJ (US)

(21) Appl. No.: 13/564,403

(22) Filed: Aug. 1, 2012

Related U.S. Application Data
(60) Provisional application No. 61/513,782, filed on Aug. 1, 2011.

(51) Int. Cl. G06Q 10/06

(52) U.S. Cl. CPC G06Q 10/0633
USPC 705/7.15; 705/7.27; 705/7.17

(57) ABSTRACT

A critical date management system includes a critical date management module (CDM), project management system, and flow management system in which the CDM dynamically and automatically links activities and tasks in an overall project. Once a project plan is submitted to the CDM, the individual tasks are dynamically assembled together along with all dependencies and temporal data to create a complete end-to-end process flow containing all of the interdependent tasks. The assembled flow is then submitted to the flow management system for execution. The modular approach allows for the dynamic creation of a complete end-to-end delivery flow for different projects and project changes without the need for complex contingency logic. The result is a service delivery process that is customized for each new project. Additionally, when changes are made to an active project plan, manual recalculating of coordinated activities will be performed by the critical date management system.

### CROSS-REFERENCE TO RELATED APPLICATIONS

This application claims the benefit of U.S. Provisional Application No. 61/513,782, filed on Aug. 1, 2011, which is incorporated by reference herein in its entirety.

### FIELD OF THE INVENTION

The present invention relates generally to critical date management method for dynamically and automatically linking activities and tasks in an overall project. Specifically, the invention concerns management of complex end-to-end service delivery project plans by driving the actual process tasks and work groups by accepting planned and updated activities from a project management plan.

### BACKGROUND OF THE INVENTION

Critical Date Management (CDM) applies to the delivery of infrastructure projects and customer service deliveries that require extensive planning and organization. CDM of the present invention allows Network Operators and Providers to use their existing project management software to plan specific tasks in their fulfillment of service delivery and then monitors, controls and drives the processes in the manner they were specified in the project plan. CDM as used herein may sometimes refer to the Critical Date Management method or Critical Date Management module comprising the present invention.

In the following description the CDM will be described in conjunction with a telecommunication application. The invention is not limited to telecommunications applications but rather to any complex project.

Processes for the delivery of end-to-end services are extremely complex and diverse. Each VPN Consumer (also called “client”) has unique communication requirements based on their business needs. A VPN Consumer is a network purchaser who purchases a VPN service or transport from a VPN provider. VPN service refers to a range of private network services including L3 IP/VPN and L2 (VLAN) Ethernet Service (E-Wire and E-Tree). There is no such thing as a one-size-fits-all service delivery process. Providers must custom build an ideal multi-site network to meet a client's individual demands. Because of the high degree of customization needed, VPN services simply do not easily lend themselves to traditional “flow-through” concepts as mass market services do. A new approach is needed. Complex planning projects (e.g. multi-site VPN service delivery, network builds and capacity augmentation) require a “project view” for overall coordination and control of the individual tasks.

Many Service Providers are struggling to manage a growing number of new clients along with all the tasks that are required to provide top-quality virtual network services to their clients (e.g., the procurement of new equipment, interfacing with external access provider services, site construction, capacity expansion, network engineering, etc.). Service Providers also face a growing number of competitors entering the industry. In order to remain competitive they need to increase the efficiency of their service delivery, strategic and tactical planning processes.

The problem is not necessarily with the individual processes themselves but rather in the management and coordination of the many individual processes as they are linked together to create complete service delivery projects. The individual processes do not have the ability to look beyond their immediate successors and predecessors. Without an overall visibility of the entire project, the individual processes can unintentionally make decisions that negatively affect the larger project.

Currently, most automated BPM (Business Process Management) engine implementations for delivering network services and managing internal projects are based upon very large, “monolithic” flows. These flows are inflexible and cannot be dynamically adjusted to account for real-world situations. Additionally, delivery flows are generally disengaged from the overall project plan.

Once a flow begins executing within the flow management system, it is left to operate autonomously, relying upon the flow designer's skill to handle any process anomalies. When an unforeseen event occurs, a “jeopardy event” is generated and the delivery process grinds to a halt while the project manager determines the proper course of action.

As the start dates of the tasks become due, CDM directs and monitors when the flow management system will execute a task flow. The flow management system is responsible for managing the task flow according to its pre-defined process. CDM allows automatic notifications to various workgroups and individuals as well as to systems that perform specific tasks (such as network element activation).

Prior solutions have been created that do not fully address this problem. They are inflexible and do not encompass the end-to-end project delivery process. Some solutions addressed the creation of segmented flows through the use of flow fragments. These flow fragments are associated with sequence numbers which are retained in an inflexible, non-configurable manner in a service catalog. Rules must be written to change the sequence numbers to account for the dependencies between the fragments.

In contrast, the present invention does not require the use of a service catalog to arrange dependencies between fragments using sequence numbers. Our solution requires dependencies to already be planned and identified by existing external project management software, methods or tools. The solution imports the planned project, identifies the tasks and creates the dependencies based upon the actual delivery process defined by the project manager/project management software. No sequence numbers are needed, the flow is dynamically assembled and intelligently reassembled for each project plan, even when the project plan changes and is resubmitted.

Many existing solutions require that the Service Provider change their existing processes in order to integrate a new solution. This is not the case with the CDM of the present invention. The present CDM can be placed unobtrusively within existing business processes and operational support structures to realize process efficiencies. It will work with existing processes and does not need to re-design them. Additionally, CDM can be applied to a portion of the overall process if desired. It is a flexible and scalable tool that can be used to target specific “problem areas” within the service provider's process.

### SUMMARY OF THE INVENTION

The present invention uses the combination of three different disciplines, Project Management, Flow Management for Operational Support Systems and Enterprise Service Delivery (business process). Automation of Enterprise Service Delivery processes are relatively new to the telecom industry and is rapidly evolving. Automated systems are just now being devised to handle the inventory and activation of these large/complex service networks. It is rare for one person or group to be looking across all 3 disciplines at the present time. Service Delivery groups are concerned with getting customers up and running as fast as possible using disjointed processes. The Project Management groups are concerned with making sure all planned tasks that support the end-to-end project delivery are being executed on time. The Flow Management Systems (OSS) attempts to capture only portions of the Service Delivery process for automation and it is inefficient to try and model every possible relationship/dependency between tasks and processes. Only portions of a Service Delivery processes are automated (e.g., provisioning and activation).

The major concepts of the invention are: Project Plan import (via XML, text file or other existing methods), Dynamic Task assembly, Dependency Processing, Technical Data Import, and Detection and Notification of Critical Date Jeopardy conditions.

The CDM Solution provides the following benefits to service providers:

Execute “as planned” project schedules and increase scalability to handle more projects; Gather and store real-time and cumulative metrics to identify areas for process improvements.

Faster Revenue Recognition
Reduced delivery intervals and reduced overall cost of a given implementation—i.e., “just in time” ordering, customer specific logistics, contractual commitments
Reduced “wait” time with notification and escalation for critical path tasks Reduce OpEx
Improved communications between internal work groups
Improved control and monitoring of end-to-end “As Planned” project management of delivery

Once a project is underway, the service delivery process runs without regard to the “as planned” project. Inevitably external events will occur that have an effect on the project. The PM (Project Manager) must rework the project plan but also has to determine which tasks are affected, the status of each task and how to reorganize the tasks that have already been submitted into the delivery process. Service delivery project plans typically consist of hundreds of coordinated tasks having multiple interdependencies.

The CDM invention is able to integrate a project plan with a flow management system so the project plan can actually drive the business and operational tasks.

Once the project plan is submitted, the individual tasks are dynamically assembled together along with all dependencies to create a complete end-to-end process flow containing all of the interdependent tasks. The assembled flow is then submitted to the flow management system for execution.

This modular approach allows for the dynamic creation of a complete end-to-end delivery flow without the need for complex contingency logic. The result is a service delivery process that is customized for each new project. Additionally, when changes are made to an active project plan, much of the manual recalculating of coordinated activities will also be automatically updated.

Task names received from the project plan are mapped to specific flows in the flow management system. Each flow can range from simple notifications to highly complex automation steps. Once under the control of the flow management system, each task can be tightly controlled and closely tracked as the execution of each task progresses.

Changes to the project plan are handled by differencing logic contained within the “CDM Module”. For example, future tasks can be automatically cancelled, in-work tasks can be gracefully terminated and completed tasks can be backed out if necessary. This relieves the PM from these time consuming and sometimes error prone activities resulting in a more efficient overall process (reducing time for order-to-cash).

The CDM Solution also provides dashboard reporting capabilities that reflect the real time status of the project initiated tasks. Executive summaries can be automatically generated to keep upper management apprised of key project milestones. Status updates can be sent to project managers (using various alerting methods) to communicate the end-to-end critical path status of the project.

Additional beneficial results include the service delivery process improvements. Efficiencies in the overall end-to-end delivery process results due to the tighter management of the individual tasks and due to the automation of workgroup/individual/system notifications. Additionally, the use of the 4 dependency structures provided by the project management system allows the CDM to provide real-time status and feedback to the project management software or project managers involved in a particular task, tightening up the delivery process.

Many Enterprise Service Providers currently use telephone, email, IM or paper to manage the execution of the dependencies of service delivery tasks. This is tedious, time-consuming and error prone. The CDM Solution allows for many of these tasks to be automated based solely upon the project plan submitted. This frees up the project manager to perform the duties of planning and managing the timely delivery of a project rather than worrying about the actual execution and constant checking on who needs to be contacted next. A simple status inquiry about a particular task would provide all the needed information.

Executives often need status updates on their key clients and large projects. Without CDM, a project manager must determine what the status of the entire project is manually, based upon the project plan which does NOT reflect the real-time view of the project. This again, is a very time-consuming and error prone process. The CDM of the present invention knows exactly what tasks have been completed, which are running and at what steps, and which have not yet started. Therefore, an automated status report can easily be generated using the CMD Module's real-time knowledge of project status.

The invention will be more clearly understood when the following description is read in conjunction with the accompanying drawings.

### BRIEF DESCRIPTION OF THE DRAWINGS

FIG. 1 is a schematic diagram of an example of a service fulfillment flow overview according to the invention.

FIG. 2 is a schematic representation of an example of a solution flow according to the invention.

FIG. 3 shows required components and system interactions of a Critical Date Management (CDM) solution.

FIG. 4 is a schematic representation of a CDM system interaction.

FIG. 5 is a Project Gant chart representation of an overall project plan.

FIG. 6 is a schematic diagram of a project plan import to a Work Flow Management System.

FIG. 7 shows examples of dependency types.

FIG. 8 is a schematic representation of task execution.

### DETAILED DESCRIPTION

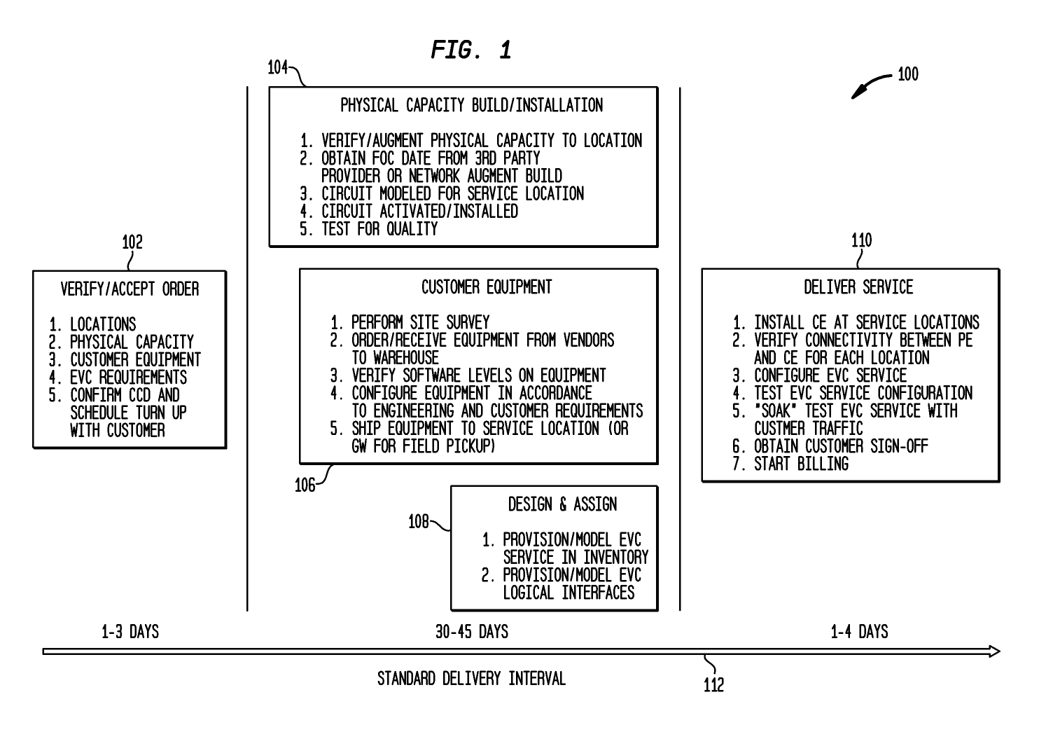

Referring now to the figures and to FIG. 1 in particular, there is shown a high level example of a service fulfillment process 100 with the various activities scheduled at key points during process. Typical processes include Verify/Accept Orders 102, Physical Capacity Build/Installation 104, Custom Equipment 106, Design & Assign 108, and Deliver Service 110. Most providers use known “standard delivery intervals” 112 for project planning these complex services (network design, ordering equipment, ASR requests, installation times, etc). These points are considered the critical dates and need to be closely monitored and managed.

Although a project plan may be created with these standard intervals it will seldom be executed as originally planned. The project plan is subject to constant variations due to real world events (equipment not available, weather related delays, clients' changing requirements, etc). As the project timeline changes, so must the tasks that are associated with the plan. This can be a very difficult and time consuming process especially when there are multiple sites and dependencies between the tasks.

The CDM solution provides a tremendous benefit to network providers by utilizing project management concepts to drive the delivery process.

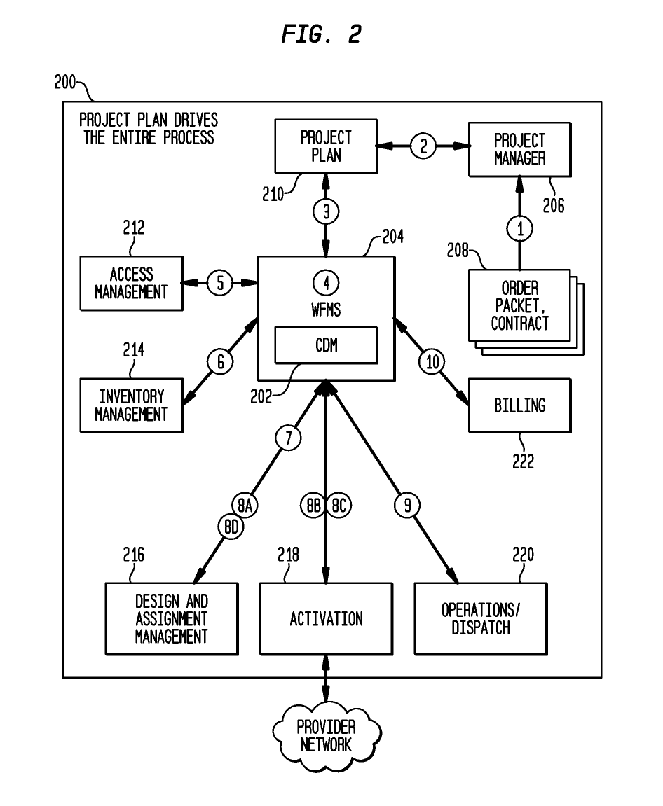

The CDM solution is based upon the Service Provider's delivery process shown in FIG. 1. In FIG. 2 the flow example shows how a Work Flow Management System (WFMS) with CDM enables a project-driven end-to-end delivery process can be used to initiate the various activities required to fulfill a Consumer's multisite request.

WFMSs have the flexibility to work with “macro” flows (flows in which notification messages are sent to workgroups or systems with responses given when task is complete) and “micro” flows (flows in which each step of a process is under control of the flow engine, e.g., assignment and activation, steps 8A-8D:

The following steps depict a potential flow scenario controlled by the CDM Module 202 through a WFMS 204:

1. Project Manager (PM) 206 receives a Verified Order & Network Plan 208 containing sites that require construction, Access, etc Locations, Physical Capacity, Customer Equipment, Service/EndPoint requirements, Confirm CCD and schedule turn up with Customer.

2. PM develops a schedule for each site based upon the Network plan, may include (but not limited to); construction, access, procurement, engineering, operations, etc. . . .

3. The PM creates the Project Plan 210 which is imported into the CDM Module via XML file (or other available methods).

4. The CDM Module translates the imported project plan task names into WFMS flow names. An end-to-end flow is then dynamically assembled based upon the dependencies and temporal data received from the imported plan then begins executing the assembled flows.

5. Physical Capacity Build/Installation (Order Access Task) 212

A. Verify/Augment physical capacity to location

B. Obtain Firm Order Confirmation (FOC) date from 3rd Party Provider or network augment build

C. Circuit modeled for Service Location

D. Circuit activated/Installed

E. Test for Quality

F. Manual Complete to the WFMS

6. Design (Manual Tasks) (Design Inventory Task)

A. Import technical data (possible Engineering Review here)

B. Model Access Circuit in Inventory Management 214

C. Model logical interfaces

D. Manual Complete to the WFMS

7. Assign VPLS Service (Assign Service Task)

A. Request Service Assignment from Design and Assignment Management 216

B. Design and Assignment assigns service and sends Success to the WFMS

C. Request EndPoint Assignments from Design & Assignment Management

D. Design & Assignment Management sends Successful Assignments to the WFMS

8. Activate VPLS Service (Activate Service Task)

A. The WFMS Requests Activation Data from Design & Assignment Management

B. The WFMS compiles service and Endpoint Activation Request and Sends to

Activation 218

C. Activation Sends “Activation Complete” to the WFMS

D. The WFMS Sends Activation Completion to Design & Assignment Management

9. Coordinated Testing (Manual Tasks) (Coordinated Test Task)

A. Dispatch & Configure Service 220

B. Test service configuration

C. “Soak” test service with Customer traffic

D. Sites send Successful Testing to the WFMS (dependencies vary)

10. Notify Billing 222

A. Obtain Customer Sign-off

B. Start billing

The CDM module acts as an integrator between the project plan and the flow management system. The CDM solution requires the following four functional components in order to accomplish project driven critical date management:
Project Management System
CDM Module
Work Flow Management System
Project Management Console

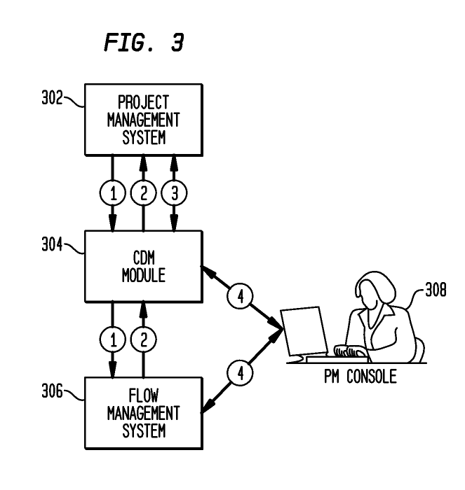

The required components for the CDM Solution and the essential System Interactions are described in FIG. 3. The sections that follow contain high level descriptions for each of these components.

The Project Management System (PM) 302, CDM Module 304 and Flow Management System (FM) 306 interact with each other in three essential areas:

1. Initial Project Load (PM>CDM>FM)
Import Project Plan
Identify associated process activities (task assembly)
Allow user to load corresponding technical data
Execute assembled tasks (FM System)

2. Workflow Driven Updates (PM<CDM<FM)
Task/Milestone completion
Manual date changes/overrides
Jeopardy Warnings/Missed deadlines (PM<CDM)

3. Project Plan Updates (PM><CDM)
Changes to dates
Changes to dependencies
New tasks
Remove tasks
Generate Warnings (back to PM System)

4. PM Console 308 (PM><CDM, PM><WFMS)
Analytics
Flow Management Reports
Task Execution Status
Task Corrections/Cancellations
Reference Data
CDM Administration

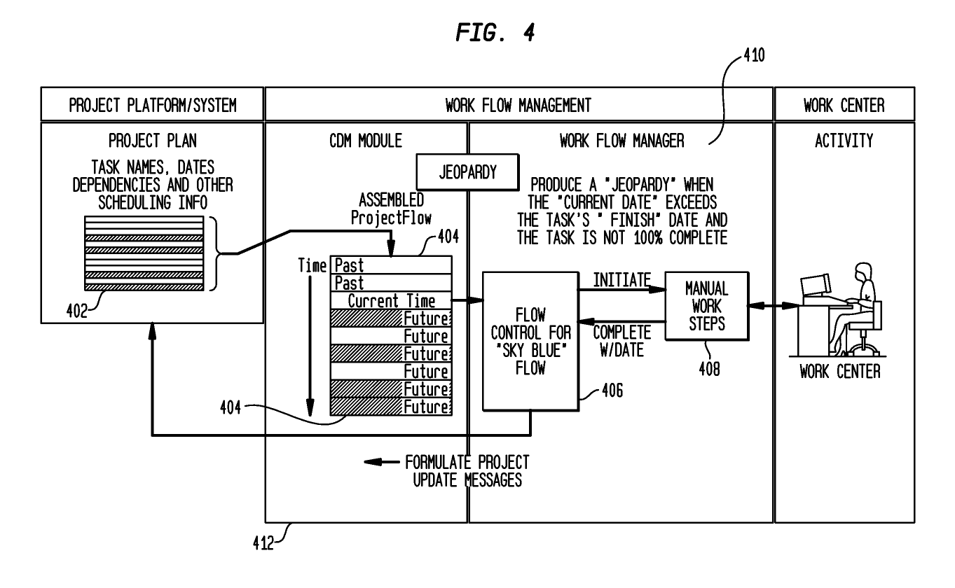

FIG. 4 shows the CDM process interacting with external components:
The CDM Module assembles the “project flow” from the imported tasks 402
It then checks 404 the Current Date/Time, Start Date/Time and the Dependencies of each task to determine if or when a task should be started, or if a task should be prevented from completing (in the case of a SF or FF dependency
In the example in FIG. 4 the Master Task Scheduler 404 determines that the “Sky Blue” task 406 should be run which causes the Work Flow Manager 410 to execute the corresponding Work Flow.
Manual steps 408 within the Work Flow Manager 410 manage the work center activity and communicate the completion back to the CDM Module 412.
The CDM Module may formulate and send update and status messages back to the PM.

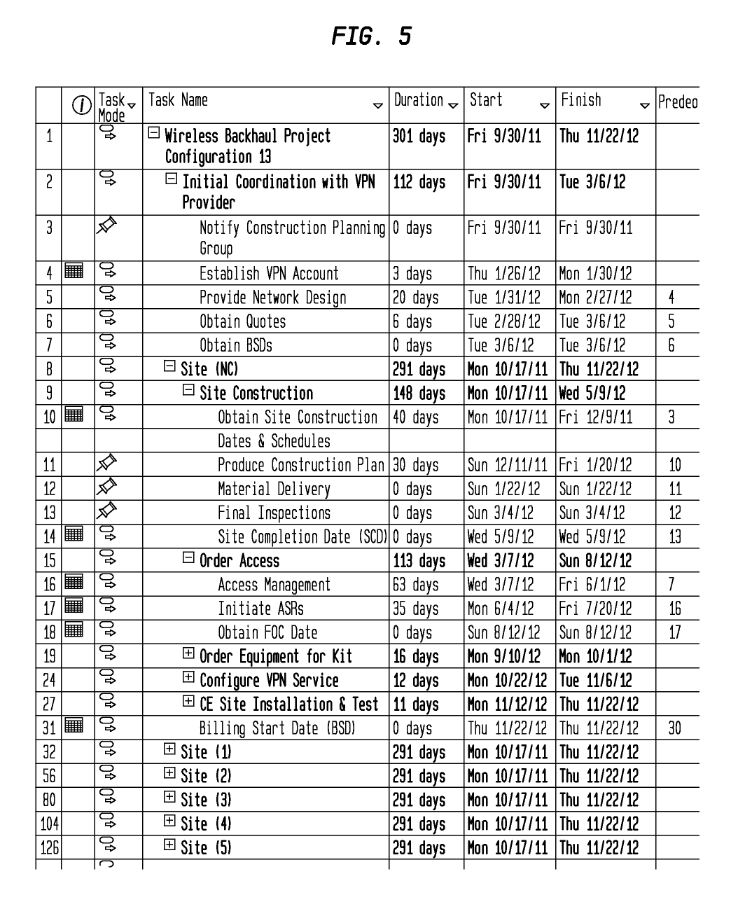

The CDM concept relies upon a documented overall project plan. The project plan represents an “ideal” road map to deliver the overall service to the client. However, in reality, all plans are subject to change and will likely require that tasks be added, reorganized or removed. This is where the CDM Solution provides the greatest potential benefit to the Service Provider. The CDM Module can directly accept XML output, spreadsheet CSV (comma separated values), or formatted text. After the tasks have been manipulated in the project plan, the CDM module imports the plan and dynamically rearranges the existing tasks in the flow management system. The illustration in FIG. 5 shows an example of a Project Gant chart for a multi-VPN service.

Summary tasks can be nested. For this example (Wireless Backhaul Project—Configuration 13) hold groups of Summary tasks (e.g., Site (NC), Site (1), etc). In this example project, each of the client's sites are represented by a Summary task called Site(n). The “Site(n)” tasks are higher level Summary tasks that contain the Summary tasks that hold the actual work tasks that are used in the WFMS to trigger the flows. For example, tasks listed in lines 10 though 14 all fall within the “Site Construction Summary”.

A Task Dependency is described as a scheduled or pending task that has an associated predecessor task. A task's start or completion can be controlled by the dependency relationship. There are four types of dependencies Finish to Start (FS), Finish to Finish (FF), Start to Start (SS) and Start to Finish (SF).

A Task Constraint is a restriction placed upon a task within the project management software so that the automatic movement of that task behaves appropriately when the project plan is changed. The following are examples of task constraints, “as late as possible”, “as soon as possible”, “finish no earlier than”, “finish no later than”, “must start on”, “must finish on”, “start no earlier than”, “start no later than”.

The Project Management System may take on many different forms, for example, a third party project management application, a project management platform, CSV spreadsheet output or text files. The CDM module acts as an integrator between the project plan and the flow controller or BPM engine.

The CDM module contains the following functionality:
Import project files
Assemble task list to form a complete Project Flow
Map project plan specified tasks to WFMS workflows
Import technical data files and map to tasks
Invoke WFMS tasks
Perform Dependency processing
Generate Warnings to PM system
Perform Change Differencing

The Flow Management system used for implementing the CDM Solution may be the Ericsson Workflow Director providing BPM Engine as well as reporting and status functionality.

The CDM Module receives tasks and dependencies from a project management platform, system, XML or text file then translates them into a form that the flow management system can utilize.

The CDM Module will need to process the structure, relationships and elements that make up tasks. The following diagram describes these relationships and attributes.

Once a project plan is completed, the CDM module imports the project file (XML, CSV, text etc.) and assembles the full project flow from the individual tasks. The dependencies and task constraints are also imported and applied to the tasks in the queue.

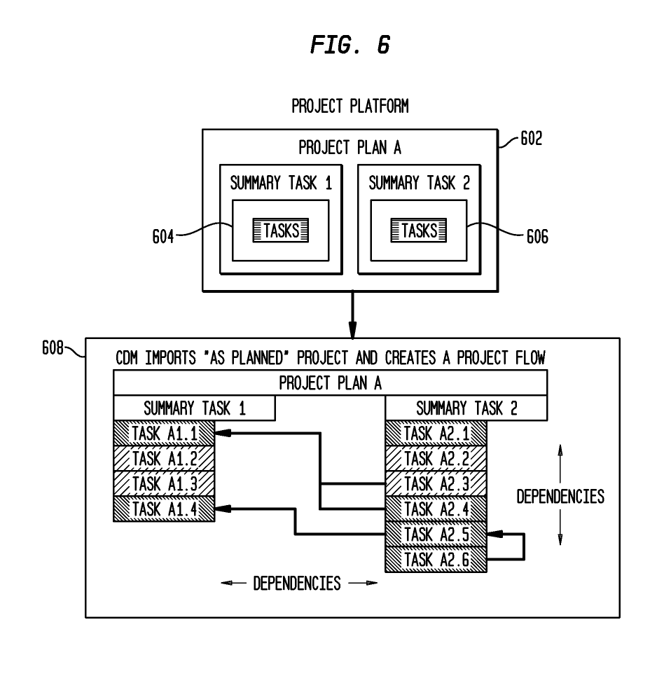

Upon importing a project plan, the CDM module will begin to assemble the task list including the dependency structure and task constraints. The assembly of the project plan (as shown in FIG. 6) into a task list can be visualized in the Table below:

| | Summary | Task | Task | Start | End | Prede- |
|---|---|---|---|---|---|---|
| Project Name | Task | ID | Name | Date | Date | cessors |
| Project Plan A | Summary | A1.1 | Red | 1.1.11 | 2.1.11 | |
| | Task 1 | A1.2 | Blue | 2.1.11 | 2.8.11 | |
| | | A1.3 | Green | 2.1.11 | 4.1.11 | |
| | | A1.4 | Gold | 4.4.11 | 4.4.11 | |
| | Summary | A2.1 | Red | 1.1.11 | 1.12.11 | |
| | Task 2 | A2.2 | Blue | 1.13.11 | 1.28.11 | |
| | | A2.3 | Green | 2.1.11 | 2.9.11 | A1.1 |
| | | A2.4 | Red | 2.1.11 | 2.28.11 | A1.1 |
| | | A2.5 | Purple | 3.1.11 | 3.20.11 | A1.4 |
| | | A2.6 | Gold | 3.20.11 | 3.30.11 | A2.5 |

The project plan is created by a project manager 602 who needs to have control of the various tasks 604, 606 that must be accomplished in order to coordinate and successfully complete the project. However, the project plan 608 does not include any of the technical information that is needed in order to complete any specific task. This “Project Data” is typically generated by many different groups within the Provider's delivery process. The technical data may be in many different forms and may be created and input at many different times.

The CDM module utilizes status information generated in the workflow management system to determine when to initiate a dependent task. Tasks that do not have all the required entered data (defined in the WFMS) will not be allowed to complete successfully.

For example, a task may specify that a router needs to be ordered for a particular site and that a PO (Purchase Order) number must be assigned in order for the task to be “complete”. The data that describes the technical details of the router (part number, bandwidth etc.) may be stored in a spreadsheet which can be imported into the WFMS platform to populate the required data items. The Procurement group may then access the data input screen to enter the PO number to complete the task. The individual tasks that are imported from the project plan will have associated data schemas which need to be satisfied before the task can be considered complete. CDM allows the list of tasks to be bound to the flows to dynamically create a complete end-to-end service delivery flow. The advantage of using smaller “building blocks” of tasks is that there is no longer a need to apply complex logic to account for all contingencies within the BMP flows. When a plan requires changing, it is simply resubmitted to the CDM module where “differencing” logic determines what tasks need to be added, removed, replaced, gracefully stopped or backed out.

The Project Plan contains the collection of tasks and WFMS contains the flows that are to be executed for each of the defined tasks. Once the CDM Module assembles the project flow, it can then instruct the WFMS to begin executing tasks. The CDM module runs in the background and checks the Start Date/Time and the Dependencies of each task to determine when a task should be started.

A mapping table exists in the CDM module where Project Task Names can be associated with the Flow Names in the WFMS. This mapping provides a layer of flexibility that allows Providers to customize the action of the work flow without having to have multiple versions of the same flow.

For example, if a customer has two regional Operation Centers, the project plan can specify different task names for each center. The mapping table will associate the two different task names to the same flow but use different “initialization data” to direct the flow to send the notification to the correct Operations Center.

Note that the “Task Mapping” table also includes a “Roll Back Procedure”. This entry identifies the flow name of a predefined “roll back” procedure that will automatically be executed when the project plan calls to remove a task that has already been completed.

The following table illustrates how different project task names can be mapped to the same flow. The initialization data is applied as an input to the work flow before execution. This allows a flow to follow different logic such as sending a notification to a different work center based upon the input data. CDM Reference data is also used to provide global input to work flows and CDM features

| Flow Name | Task Name | Initialization Data | Roll Back Procedure |
|---|---|---|---|
| Notify Operations | Notify East Operations | ADDR: 1 Telcordia Drive, | Roll Back East Ops |
| | | Piscataway NJ | Notification |
| | | EMAIL: opeast@teclodia.com | |
| | | CONTACT: John Doh | |
| | Notify West Operations | ADDR: 5 Fault Ln, San Andreas, | Roll Back West Ops |
| | | CA | Notification |
| | | EMAIL: opwest@teclodia.com | |
| | | CONTACT: J. Garcia | |
| Order Access | Order Fiber Access | WORK CENTER: Fiber Access | n/a |
| | | Group | |
| | Order Wireless Access | WORK CENTER: Wireless Access | Roll Back Wireless |
| | | Group | Access |
| | Order DSx Access | WORK CENTER: General Access | n/a |
| | | Group | |

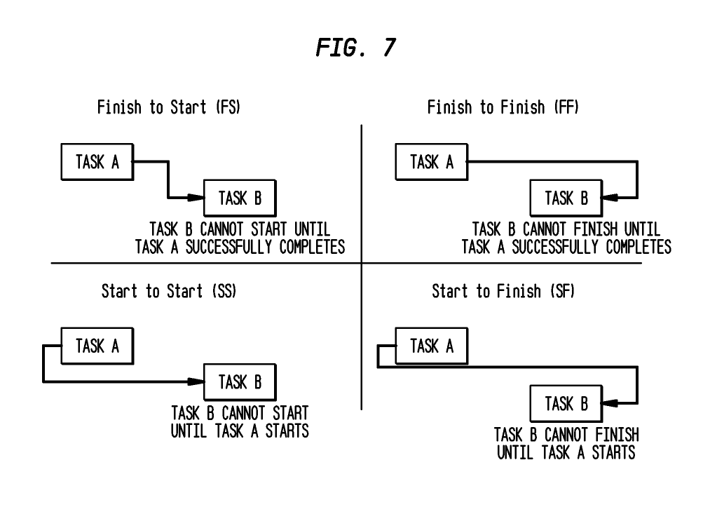

The CDM Module is aware of the dependencies and task constraints received from the project plan. When there are no task dependencies the task is initiated in a WFMS when the Start Date/Time is reached. A task can be prevented from starting or completing if desired by using dependencies. FIG. 7 shows four types of project dependencies used in project management (listed in order of decreasing frequency of use):
Finish to Start (FS)—A task cannot start until the dependent task completes
Finish to Finish (FF)—A task cannot finish until the dependent task completes
Start to Start (SS)—A task cannot start until the dependent task starts
Start to Finish (SF)—A task cannot finish until the dependent task starts

The Finish to Start (FS) dependency (most commonly used) prevents a task from starting until the dependent task has completed.

For example, activating an EndPoint is dependent upon first having the router equipment installed. An FS dependency would be set up in the project management software and sent to the CDM Module. The CDM Module would prevent the “Activate EndPoint” task from starting until the “Install Equipment” task has successfully completed.

When a task cannot be started on its “Start Date/Time” (or completed on its Finish Date/Time) because of a dependent task then a “Jeopardy” can be generated by the CDM Module.

Jeopardies can be handled by sending all the relevant information about the task to the appropriate work group or person. The status of the task is also kept in the CDM Module so that real-time reports could be generated.

Various jeopardy scenarios can be created based upon the dependencies. The following Table shows how the CDM Module will process dependencies based upon Dependency types and Task Start/End dates. Note that a task may only be assigned one Dependency type and the default type is “None”.

The Table below shows some of the logical processing that takes place in the CDM Module.

| | | | Action Taken | |
|---|---|---|---|---|
| | Date | Predecessor | If Steps Incomplete | If All Steps Complete |
| Constraint Type | Status | Status | (for working task) | (for working task) |
| None | CD < SD | n/a | n/a (task not due to start) | Start Task/Alert = Task finished |
| | | | | early |
| | CD = SD | n/a | Start Task | Start Task/Alert = Task finished |
| | | | | early |
| | CD > SD | n/a | n/a Tasks w/o predecessors are | Complete Task/Alert = Task |
| | | | always started | finished early |
| | CD = FD | n/a | Alert = Task behind schedule, | Complete Task |
| | | | late to finish | |
| | CD => FD | n/a | Alert = Task behind schedule | Complete Task/Alert = Task |
| | | | | finished late |
| Finish to Start | CD < SD | C | n/a (task not due to start) | n/a (task not due to start) |
| task cannot start | | I | n/a (task not due to start) | n/a (task not due to start) |
| until the dependent | CD = SD | C | Start Task | Complete Task |
| task completes | | I | No Start/Alert = Task cannot | n/a |
| | | | start, dependency not finished | (task never started) |
| | CD > SD | C | Task in-work/or Alert if task not | Complete Task/Alert = Task |
| | CD < FD | | started | finished early |
| | | I | No Start/Alert = Task cannot | n/a |
| | | | start, dependency not finished | (task never started) |
| | CD = FD | C | Alert = Task behind schedule, | Complete Task |
| | | | late to finish | |
| | | I | No Start/Alert = Task cannot | n/a |
| | | | start, dependency not finished | (task never started) |
| | CD > FD | C | Alert = Task behind schedule, | Complete Task/Alert = Task |
| | | | late to finish | finished late |
| | | I | No Start/Alert = Task cannot | n/a |
| | | | start, dependency not finished | (task never started) |
| Finish to Finish | CD < SD | C | n/a (task not due to start) | n/a (task not due to start) |
| task cannot finish | | I | n/a (task not due to start) | n/a (task not due to start) |
| until the dependent | CD = SD | C | Start Task | Complete Task |
| task completes | | I | Start Task | Start Task/Alert task cannot |
| | | | | complete, dependency not |
| | | | | finished |
| | CD > SD | C | Task in-work/or Alert if task not | Complete Task/Alert = Task |
| | CD < FD | | started | finished early |
| | | I | Task in-work/or Alert if task not | Task finished/Alert = Task |
| | | | started | cannot complete, dependency |
| | | | | not finished |
| | CD = FD | C | Alert = Task behind schedule, | Complete Task |
| | | | late to finish | |
| | | I | Alert = Task behind schedule, | Alert = Task behind schedule, |
| | | | late to finish | dependency not finished |
| | | | Alert = Task behind schedule, | |
| | | | dependency not finished | |
| | CD > FD | C | Alert = Task behind schedule, | Complete Task/Alert = Task |
| | | | late to finish | finished late |
| | | I | Alert = Task behind schedule, | Alert = Task behind schedule, |
| | | | late to finish | dependency not finished |
| | | | Alert = Task behind schedule, | |
| | | | dependency not finished | |
| Start to Start | CD < SD | C | n/a (task not due to start) | n/a (task not due to start) |
| task cannot start | | I | n/a (task not due to start) | n/a (task not due to start) |
| until the dependent | CD = SD | C | Start Task | Complete Task/Alert = Task |
| task starts | | | | finished early |
| | | I | No Start/Alert = Task cannot | n/a |
| | | | start, dependency not started | (task never started) |
| | CD > SD | C | Task in-work/or Alert if task not | Complete Task/Alert = Task |
| | CD < FD | | started | finished early |
| | | I | No Start/Alert = Task cannot | n/a |
| | | | start, dependency not started | (task never started) |
| | CD = FD | C | Alert = Task behind schedule, | Complete Task |
| | | | late to finish | |
| | | I | Alert = Task behind schedule, | n/a |
| | | | dependency not started | (task never started) |
| | CD > FD | C | Alert = Task behind schedule, | Complete Task/Alert = Task |
| | | | late to finish | finished late |
| | | I | Alert = Task behind schedule, | n/a |
| | | | dependency not started | (task never started) |
| Start to Finish | CD < SD | C | n/a (task not due to start) | n/a (task not due to start) |
| task cannot finish | | I | n/a (task not due to start) | n/a (task not due to start) |
| until the dependent | CD = SD | C | Start Task | Complete Task/Alert = Task |
| task starts | | | | finished early |
| | | I | Start Task | Start Task/Alert = Cannot |
| | | | | complete task, dependency not |
| | | | | started |
| | CD > SD | C | Task in-work/or Alert if task not | Complete Task/Alert = Task |
| | CD < FD | | started | finished early |
| | | I | Task in-work/or Alert if task not | Alert = Cannot complete task, |
| | | | started | dependency not started |
| | CD = FD | C | Alert = Task behind schedule, | Complete Task |
| | | | late to finish | |
| | | I | Alert = Task behind schedule, | Alert = Cannot complete task, |
| | | | late to finish | dependency not started |
| | | | Alert = Task behind schedule, | |
| | | | dependency not started | |
| | CD > FD | C | Alert = Task behind schedule, | Complete Task/Alert = Task |
| | | | late to finish | finished late |
| | | I | Alert = Task behind schedule, | Alert = Cannot complete task, |
| | | | late to finish | dependency not started |
| | | | Alert = Task behind schedule, | |
| | | | dependency not finished | |

The CDM Module accounts for the Constraint Type, Date Status (relative to the current date) and whether or not the Predecessor completed successfully. The CDM Module will perform the action shown under the “Action Taken” heading depending upon these factors and whether or not all the steps of the executing task have been completed.

Note the following general rules regarding how the CDM module initiates tasks in the WFMS:
A task is late to start when: Current Date>Start Date
A task is late to complete when: Current Date>Finish Date
CDM module automatically starts a task on its Start Date/Time and all of its predecessors have successfully completed by their Finish Date/Time.
The CDM Module considers a task “incomplete” when the Current Date (CD)>Finish Date (FD) or when
   the Late to Finish (LTF) Alert parameter is set and the calculated date/time falls within that specified range.

The abbreviations used in this table are CD=Current Date/Time, SD=Start Date/Time, FD=Finish Date/Time, I=Incomplete, C=Complete.

Project Managers need to be made aware of tasks that do not complete on time or are in danger of not completing on time. Note that a task can never be “late to start” since the CDM module automatically invokes the WFMS task when the CD=SD. A task can only be “late to start” when it has predecessors that cannot complete on time. In this case the LTF parameter will suffice for alerting both the late task and its successors.
LTF: Late to Finish—A task is considered to be late to finish when the current date/time has gone beyond the Plan Finish date/time by the percentage of time specified by the reference data relative to the task duration. Alert when: The PctAllowed can be either a positive or negative value. When the LTF Alert parameter is set to a positive value, the CDM module will allow additional time to pass before Alerting. When it is set to a negative value, the CDM module will issue an advanced alert. Other dependency types (FF, SF and SS may have slightly different behaviors.

After a project plan is submitted to the CDM Module, any additional changes to that plan must be reflected in the flow management system. Changes are handled by the CDM Module by comparing the current plan to the new plan. The key to making this possible is to identify each task with a unique identifier (UID) within a project plan. The UID is associated with the task from the time the task is created, through any changes to that task and is retired when the task is deleted. A deleted task's UID is never reused in a given project plan regardless of the number of changes to the plan. The CDM Module's change processing (differencing) utilizes this principle in order to determine how to adjust the currently executing tasks within the flow management system.

The CDM Module must be aware of the status of any give task in order to process changes for that task. The following Execution Statuses are provided with the CDM Module:
Scheduled
Pending
Pending-Late
Running
Running-Late
Complete
Failed

Differencing logic within the CDM Module, such as shown below, will be provided to determine how to handle any task changes that deviate from the initial project plan.

Upon receiving a changed project plan the CDM Module will perform the following:

1. Gather list of all existing task IDs (in the WFMS system)

2. Gather list of all submitted task IDs on the changed plan

3. When a Task ID exists in the WFMS but not on changed plan—CDM marks the task for REMOVAL

4. When Task ID exists in both WFMS and in Changed plan—Task is marked for CHANGE

5. When Task ID exists on changed plan but NOT in the WFMS—the Task is marked for INSERT

The following table depicts an example of which actions the CDM Module should take based upon the type of change required (e.g., Remove, Change, Insert) and the status of the task being changed.

Master Task Scheduler Actions based on Status

| | Pending | Executing | Completed |
|---|---|---|---|
| Remove | Remove the task from | Stop Task or allow to | Archive or possibly notify |
| | Work Director | gracefully complete | for “back-out” |
| Change | Overwrite task ID in Work | Stop Task or allow to | Archive or possibly notify |
| | Director with changed | complete | for “back-out” |
| | Task from plan | Stop Task and notify for | If completed task has a |
| | | “back-out” | date in the future, then |
| | | Re-queue new task from | overwrite task and re- |
| | | project plan with new | queue task with new |
| | | parameters | parameters |
| Insert | Insert the task and apply | New tasks with past due | n/a, new tasks can't even |
| | any dependencies as | dates may begin | be in Work Director to |
| | required | executing immediately | have been completed |

The CDM module contains the following functionality:
Import project files

This section describes the required interactions between the Project Plan, CDM and BPM/Flow engine.

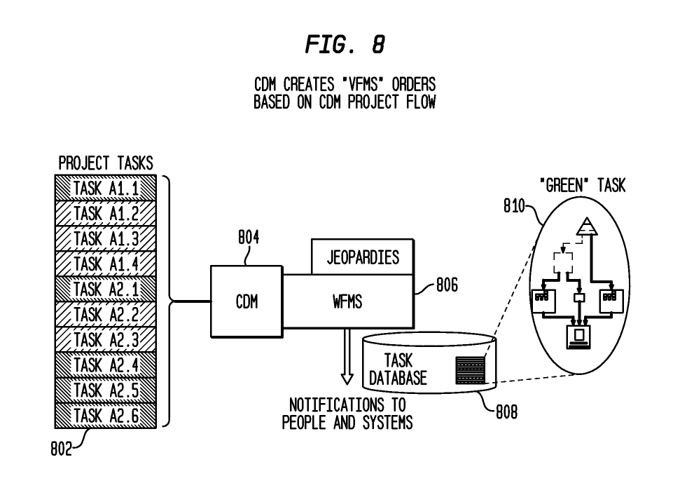

As shown in FIG. 8 below, there must be an actual flow associated with each Task 802. The CDM module 804 maps the Task Name received from the project plan to the flows in the WFMS 806 database. The flows contain the distinct steps needed in order to complete the desired task. They must be designed to be granular enough to complete a specific task 808 but also flexible enough to be used for varying conditions. For example, a task 810 that initiates an installation dispatch must allow variables for dates, times, equipment type, durations etc.

While there has been described and illustrated a Critical Data Management method dynamically and automatically linking activities and tasks in an overall project, it will be apparent to those skilled in the art that modifications and variations are possible without deviating from the broad principles and teachings of the invention which shall be limited solely by the scope of the claims appended hereto.

What is claimed is:

1. A critical date management system comprising:
critical date management module;
project management system imports a project plan to the critical date management module causing the critical date management system to associate and assemble tasks with process activities and accepting technical data; and
flow management system for executing the assembled tasks.

2. The system as set forth in claim 1, where said flow management system tracks task completion and responsive to the tracking said critical date management system changes dates.

3. The system as set forth in claim 1, where said flow management system tracks task completion and responsive to the tracking said critical date management system overrides the project plan.

4. The system as set forth in claim 1, where said flow management system tracks task completion and responsive to the tracking said critical date management system sends warnings to said project management system.

5. The system as set forth in claim 1, where said flow management system tracks task completion and responsive to the tracking said critical date management system changes task dependencies, removes tasks, and creates new tasks.

6. A critical date management system comprising:
project planner for receiving project information data and developing a schedule based on the data and creating a project plan of tasks; and
critical date management module receives the project plan and maps the project plan into Work Flow Management System (WFMS) flow names and fauns an end-to-end flow based on task dependencies and temporal data.

7. The system as set forth in claim 6, further comprising design and assignment management module for assigning services.

8. The system as set forth in claim 6, further comprising an activation module for implementing the tasks of the WFMS flow responsive to the contingencies of the tasks.

9. The system as set forth in claim 6, wherein said critical date management module inputs the project plan by means of at least one of an XML output, spreadsheet CSV (comma separated values), or formatted text.

10. The system as set forth in claim 6, wherein the tasks are associated with dependencies which control scheduling of the tasks.

11. The system as set forth in claim 6, wherein said critical date management module includes differencing logic for detecting changes to the project plan and creating an updated project plan to the WFMS.

12. The system as set forth in claim 11, wherein the differencing logic detects changes to the updated project plan and creates a further updated project plan to the WFMS.
